(19) United States
(12) Patent Application Publication
(10) Pub. No.: US 2005/0161403 A1
(43) Pub. Date: Jul. 28, 2005

(54) Apparatus and method for water treatment by adsorption

(76) Inventor: John Simms, Coventry (GB)

Correspondence Address: D'AMBROSIO & ASSOCIATES, P.L.L.C., 10260 WESTHEIMER, SUITE 465, HOUSTON, TX, 77042, US

(21) Appl. No.: 10/204,998

(22) PCT Filed: Feb. 26, 2001
(86) PCT No.: PCT/GB01/00822

(30) Foreign Application Priority Data
Feb. 25, 2000 (GB) 0004579.9

(51) Int. Cl. C02F 1/42

(52) U.S. Cl. 210/670

(57) ABSTRACT

The present invention relates to an apparatus and method for removal of arsenic or other metal salts from drinking water. The invention uses a bed of granulated ferric hydroxide to adsorp the metal in a pressurized adsorption chamber. The bed is sized to about 10 m³ and run with an EBCT of about 3 minutes which has been found to give an unprecedently long bed life of upto 200,000 bed volumes of treated water.

This application is submitted under 35 USC 371 as the national stage application of International application number: PCT/GB01/00822 filed Feb. 26, 2001 claiming priority to GB 0004579.9 filed Feb. 25, 2000.

### FIELD OF INVENTION

The present invention relates to a method and apparatus for arsenic or other metal removal from water, in particular but not exclusively, potable ground water.

### BACKGROUND

Ground water represents an important source of drinking water but has been found to contain dissolved metal ions such as arsenic, copper, nickel, chromium, lead, cadmium, molybdenum, silver, mercury and manganese, often at undesirable levels.

For example, recent regulations have stipulated that the level of arsenic should be less than 10 μg/l. Arsenic and other metals may be removed from water by using one or more of the following methods; (i) adsorption by activated aluminium, (ii) nanofiltration, (iii) in a clarification/filtration plant using overdosing coagulation; or (iv) ion exchange. Each of these processes has disadvantages. Activated aluminium has a limited adsorption capacity. Nanofiltration allows comparatively slow processing rates. The construction of a coagulation plant has a high capital cost due to e.g. the large amount of land required and high operating costs.

### SUMMARY

The present invention seeks to provide an advantageous apparatus and method for the removal of metals.

According to a first aspect of the present invention there is provided an apparatus for removing metals from water comprising an adsorption chamber including a bed having a bed height and comprising a ferric material, a water inlet connectable to a first water supply on one side of the bed, a water outlet on the other side of the bed and a backwash inlet connectable to a second water supply on the said other side of the bed, the apparatus being arranged for normal and backwash operations, in normal operation arsenic is adsorbed onto the bed from water flowing from the said one side to said other side, and in backwash operation water flows from the backwash inlet to said one side of the bed, the bed is between 0.5 m and 2.0 m, preferably at least 1.0 m, and the empty bed contact time (EBCT) is between 1 and 6 minutes.

According to a second aspect of the present invention there is provided a process for removing metal from water comprising the steps of:
a) providing a bed of ferric material having a bed height of between 0.5 and 2.0 m;
b) in normal operation supplying water from a first water supply from one side of the bed to the other side of the bed such that arsenic is adsorbed from the water onto the bed;
c) in backwash operation supplying water from a second water supply from said other side of the bed to said one side of the bed so as to remove contaminating material from the bed without substantially disrupting the media; wherein in normal operation, the empty bed contact time for said water is between 1 and 6 minutes.

The present inventors have found that using a bed of ferric adsorption media allows increased metal adsorption when compared to activated aluminium (wt/wt) with the consequential reduction in the cost associated therewith. Surprisingly, given the fragile nature of the bed, a long interval between backwashing cycles is possible without clearly increasing the differential pressure across the bed and/or without significant reduction in the adsorption rate and capacity of the bed. Furthermore the bed of adsorption material required by the present invention is made from a material which is relatively fragile in nature and so has been proportioned to allow the bed to be formed by educting the material into the adsorber without the bed material being disrupted. Yet the bed maintains sufficient size to allow the treatment of commercial volumes of water. Surprisingly, it has been found that the adsorption bed of the invention can treat an unprecedently large volume of water before replacement i.e. when it reaches the allowed/set limit for the metal being removed from the water, e.g. in the case of arsenic the treated water having 10 μg/l arsenic. The bed size in conjunction with the EBCT provide an adsorber with a high capacity, yet the bed size is not so great to cause logistical problems in maintaining the bed. This is important as the apparatus may well be in a remote location where complicated and/or frequent maintenance would greatly increase costs for the process. The adsorption bed of the present invention should not need to be replaced more frequently than once per annum which is considered to be commercially acceptable given the cost of the material.

Preferred features of the invention have been given in the dependent claims. The preferred features have each been found to improve the cost efficiency of the plant and may be used together or individually.

The use of a ferric adsorption material was also found to allow relatively high rates of metal adsorption and a reduction in the capital expenditure required to build a plant when compared to a sludge plant.

Ferric oxide and hydroxide containing natural materials have been found to be both relatively cheap to use and to give satisfactory adsorption efficiencies e.g. the ability to adsorb large quantities of arsenic, typically 1.3 g to 3.5 g of arsenic is removed per Kg of Ferric Hydroxide. The use natural material containing these two compounds has been found to give high economy and high adsorption.

Advantageously according to the first and second aspects of the present invention a layer of gravel separates the media from the support base. Gravel has been found to be an economic inert material to use which is widely available.

Advantageously according to the first, second and third aspects of the invention the pH use is in the range of 6.5 to 8.5, particularly 7.0 to 8.0 and more particularly, 7.8 during normal operation. The adsorption of arsenic is satisfactory within this PH range and normally this means that no adjustment to the PH is required for processing greatly reducing the cost and complexity of the operating condition which latter advantage is very important given the plant is normally unmanned.

### BRIEF DESCRIPTION OF THE DRAWINGS

The invention will now be described with reference to the accompanying drawings, in which:

FIG. 1 is a schematic illustration of a arsenic adsorption plant according to the present invention;

FIG. 2 shows a vertical cross sectional view through an adsorber according to FIG. 1; and

FIG. 3 shows a horizontal cross sectional view of an adsorber according to FIG. 1.

### DETAILED DESCRIPTION OF DRAWINGS

The present invention is exemplified with the following description and drawings which show an arsenic adsorption plant. The invention is not limited to arsenic adsorption, but this is the preferred embodiment of the invention. The metal can be selected from the group consisting of arsenic; copper; cadmium, nickel; chromium; silver; lead; molybdenum; manganese; and mixtures thereof.

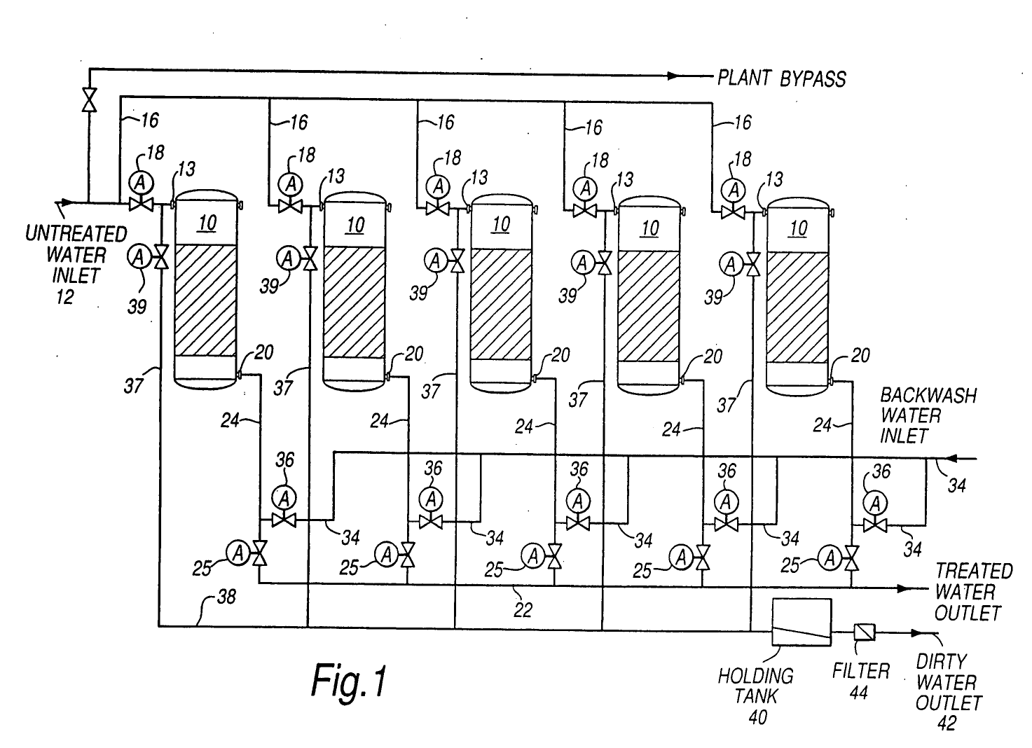

FIG. 1 shows a plant according to the present invention which has five adsorbers 10 operating in parallel. Although the present invention can function with a single adsorber it is preferred, the reasons which will become apparent below, to have a plurality of adsorbers 10.

Water to be treated flows from water inlet 12 through inlet line 14 to the inlet 13 of each of the adsorbers 10. The water supplied normally comes from a ground water source. The inlet line 14 has an inlet branch 16 to each of the adsorbers 10. Each inlet branch 16 includes an inlet control valve 18 which is controllable to allow water flow into the particular adsorber 10 to which respective branch 16 extends. The water inlet 12 may be diverted around the plant via a dedicated bypass line.

In the illustrated embodiment the water inlet 12 is supplied from a mixing tank (not shown) upstream of the water inlet 12.

Each inlet control valve 18 is arranged to allow a predetermined rate of water flow into the respective adsorber 10. Water flow through inlet branch 16 will be prevented in certain instances, for example during backwashing cycles of the adsorber 10 and commissioning cycles of the adsorber 10 as explained in more detail below. In other cases the inlet control valve 18 is adjusted to provide a proportion of the water to be treated into the adsorber 10.

Each adsorber 10 has a water outlet 20 opening into an outlet line 22 via a respective outlet branch line 24. Each outlet branch line 24 is provided with an outlet branch valve 25 between the adsorber outlet 20 and the outlet line 22.

The illustrated plant is also provided with backwash and conditioning wash cycles for backwashing and conditioning washes of the adsorber 10. In the illustrated embodiment the water is arranged to flow substantially in the reverse direction through each adsorber 10 in backwashing cycles. In the illustrated embodiment, the inlets for the backwashing and conditioning washes are formed from the adsorbers outlets 20 and the outlet for the backwashing and conditioning water is formed through the water inlet 13 in the adsorber 10. Thus, the inlet/outlet 13,20 in the adsorber 10 perform multiple functions and this is advantageous in reducing the required ports into the adsorber 10. This is preferred in the present invention though of course separate inlet/outlets could be provided for in each washing cycle or the backwashing and conditioning washes may have a separate inlet and outlets compared to the normal wash cycles which may be advantageous where the flow rate and volumes between backwashing and normal operation are particularly different.

In the illustrated embodiment the backwash inlet line 30 is fed from backwash pumps 32. The backwash line 30 has backwash inlet line branches 34 to each adsorber 10. The backwash line 30 is also used for conditioning washes.

Each backwash inlet line branch 34 opens into the respective outlet branch line 24 between the adsorber outlet 20 and the outlet branch line valve 25.

The backwash inlet line branch 34 has a backwash inlet line valve 36 immediately before opening into the outlet line branch 24. This valve 36 prevents water flow through the backwash when the inlet line branch 34 is in normal operating cycle; and, as will be apparent operates in conjunction with outlet line branch valve 25 to allow water flow through the backwash line 30, 34 in backwashing and in conditioning cycles whilst at the same time valve 25 prevents flow through outlet branch line 24 to the outlet line 22.

In a backwashing cycle and conditioning wash cycles, water is outlet from the adsorber 10 through the water inlet 13. A backwash-outlet line 38 is linked to each adsorber via backwash outlet line branch 37. The inlet control valve 18 is provided in the inlet line branch 16 which is closed during backwashing and conditioning cycles to prevent water flow towards the water inlet 12. A corresponding backwash outlet branch valve 39 is provided in the backwash-outlet branch 37 which prevents flow through this line 37 during normal cycles of the apparatus, but allows water flow through this line 37 during backwash and conditioning wash cycles. The inlet line branch 16 opens into the backwash outlet branch line 37 between the valve 19 and the inlet 13. The apparatus is arranged for backwash operation having a flow rate of less than 50 m/h, preferably less than 30 m/h.

Each backwash-outlet line branch 37 opens into the backwash outlet line 38 which feeds either into a holding tank 40 or directly to a waste outlet, e.g. a sewer 42. In backwashing cycles, the apparatus is normally designed to feed into the holding tank 40 which is provided as a settlement tank to allow particulate matter washed out of the adsorbers 10 to settle. The tank 40 is provided with a top water draw-off device and the cleaned water from which outputs to the water outlet 42. A pump can be provided to pump the water from out of the holding tank 40 if desired. Preferably, a forward flush immediately precedes a backwash operation. Tthe apparatus is structured such that the forward flush comprises less then about 10 bed volumes of water and comprises flushing water from the second supply from the said one side of the bed to the said other side of the bed. The height of the bed is between 0.5 m and 2.0 m, preferably at least 1.0 m. Preferably, the forward flush has a flow rate of less than 30 m/h, more preferably, the forward flush has a flow rate of less than 25 m/h.

In the conditioning washing cycles of the apparatus, the conditioning wash waters are directed directly to the outlet 42 through a filter arrangement 44. In conditioning washes, considerably more particular matter is washed out of the adsorbers and the use of the filter cartridges 46 therefore removes this particulate matter before the water is outlet to waste. There are of course requirements on the quality of water allowed to pass to waste. Use of the cartridge filter then means that the cartridge can then be removed after a conditioning cycle and disposed of separately. It has an advantage in so far as the holding tank volume can be greatly reduced if it does not have to be used for conditioning washes as well as back washes. Preferably, the conditioning cycle comprises an initial bed stratification backwash, a final conditioning backwash and a final conditioning forward flush. In another aspect, the initial bed stratification backwash comprises about 4 bed volumes of water at about 30 m/h.

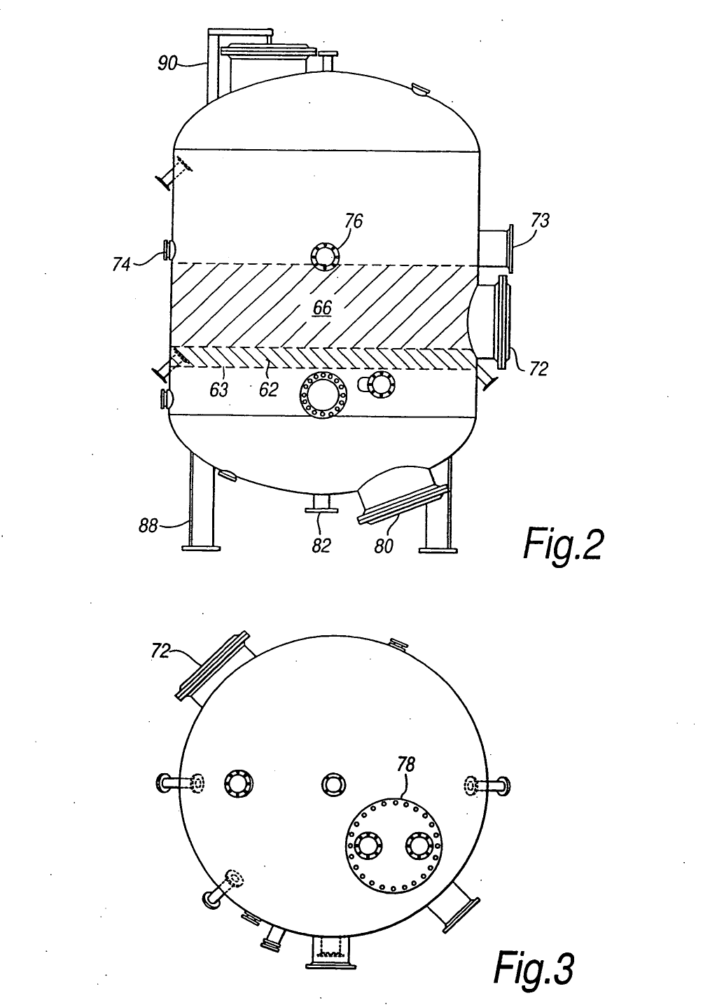

Exploded cross-sections of the adsorbers 10 are shown in FIG. 2. From FIG. 2 it is clear that in the illustrated embodiment the adsorber 10 comprises a substantially cylindrical casket with domed closures at the top and bottom. The adsorber 10 has an inlet 13 and an outlet 20 through which water is pumped through the chamber. In normal cycle, water enters through the inlet 13, passes down the chamber to the outlet 20. In backwashing and conditioning cycles water mainly through the outlet 20 and exits via the inlet 13, though of course in forward flush modes water travels in the same direction as the normal cycle. The adsorber 10 includes a base 62 which supports a media column 64. The base is located above the outlet 20. The column 64 extends from the base 62 to just below the inlet 13. The media column 64 comprises a thin layer of gravel 68 over which particulate adsorption media 66 rests. The adsorption media 66 must adsorb arsenic thereonto from water.

In the illustrated embodiment the adsorption media 66 is a particulate ferric oxide material produced from a naturally mined ore. This has been treated to have an average diameter of less than 2 mm and more than 0.25 mm. In the illustrated embodiment, less than 10% of the granules have a diameter greater than 2 mm and less than 5% of the granules have a diameter of less than 0.25 mm. The average diameter is approximately 0.8 mm. In the granulization process of the ferric material, the grain density is adjusted to between 1 and 2 kg/dm³ and is preferably within a range of about 1 .kg/dm³ to 1.7 kg/dm³ and, more preferably in the region of 1.58 kg/dm³. The average bulk density at 45% water content should be above 1.1 g/cm³, but no more than 1.4 g/cm³. The bulk density in the illustrated embodiment is controlled to 1.25 g/cm³. The granules are controlled to have a particular surface about 1.6×10⁻⁵ m²/dm³. The natural material contains at least 50% by weight iron. The granulated ferric material of this nature has a very high adsorption of arsenic which allows unprecedently long bed lifes. Also through the control of the properties as described above, the material is substantially more robust than untreated material which allows it to be handled and used. The untreated material has been found to smash when pouring into adsorbers and can not form a useable media bed.

Alternatively the granulated ferric material is formed synthetically. The synthetic material will be treated to produce similar robustness and surface features to allow the high adsorption and handability of the naturally formed material. The naturally produced material is slightly preferred at present in view of the cost of a naturally produced material compared to a synthetic material. However, it is expected that synthetic manufacturing processes will be able to produce a synthetic material at an acceptable cost for commercial situations, even though they may be about 20% also more expensive than a naturally formed material. The advantages of a synthetic material are that the adsorption capacity may be even higher than a naturally produced material in view of the purity of the synthetic constituents. Table 1 shows the constituents of a preferred synthetic material which may be used as the adsorption media 66. One preferred process comprises the step of replacing the ferric material after at least 120,000 bed volumes of water have been treated in normal operation.

The gravel base layer 68 is put into the media column on the base 62 in order to prevent the granulated material 66 being washed from the adsorber 10 through the base 62. The base 62 must be provided with through openings 63 in order to allow backwashing flow and thus the small granular size ferric material may be washed through these openings 63. This immediate layer 68 of gravel prevents such loss. Of course, other supports could be used instead of gravel. The base 62 may be provided with nozzle openings 63 on a platform or alternatively may comprise a header and lateral pipework arrangement fitted with either mesh sleeves or nozzles.

Turning now to FIG. 2, it will be clear that there are several ports into the adsorber 10. There is a manway 72 located about half way down the chamber. This is provided to allow access to the interior of the chamber. There are sight glasses 74, 76 located to allow visual inspection of the interior of the chamber. Main port 78 is provided to allow the media to be poured into the chamber from the top thereof. There is also a main outlet port 80 provided to allow access to the underside of the nozzle plate, next thereto is a smaller port 82 to act as a drain outlet.

Above the main inlet port 78 a davit 90 is provided which is used when filling the chamber with the media columns 64.

The adsorber 10 is supported on four legs 88.

Each of the adsorbers 10 are substantially the same as in the illustrated embodiment, though sizes and detailed construction may vary in particular installations.

It is preferred to have a plurality of adsorbers, rather than a single larger adsorber. The plurality of adsorbers allows one of the adsorbers to be taken offline, e.g. for backwashing and refilling of media column 64, whilst the other adsorbers take the flow which would normally be processed by the adsorber taken out of line.

The present invention relates to an apparatus and method for removal of arsenic or other metal salts from drinking water. The invention uses a bed of granulated ferric hydroxide to adsorp the metal in a pressurized adsorption chamber. The bed has a bed volume capacity of at least 10,000 bed volumes of water to be treated during normal operations. Alternatively, the bed volume is at least 30,000 bed volumes and preferably, 60,000 bed volumes of water to be treated during normal operations between backwash operations. During backwash operations, the bed has a bed volume capacity ranging from about 5 bed volumes of water to about 10 bed volumes of water.

The bed is sized to about 10 m³ and run with an EBCT of about 3 minutes which has been found to give an unprecedently long bed life of upto 200,000 bed volumes of treated water.

1. An apparatus for removing metals from water comprising:
an adsorption chamber including a bed adapted to absorb metals, the bed having a bed height ranging from about 0.5 m to about 2.0 m, the bed comprising a ferric material, the ferric material comprising a granular ferric material having a grain density ranging from about 1 kg/dm³ to about 2 kg/dm³;
a water inlet connectable to a first water supply on one side of the bed;
a water outlet on the other side of the bed;
a backwash inlet connectable to a second water supply on the said other side of the bed;
wherein the apparatus is structured for normal operations and backwash operations, during normal operations, the apparatus is adapted for absorption of metals onto the bed as water flows from said one side to said other side, and the apparatus is structured for backwash operations as water flows from the backwash inlet to said one side of the bed and the empty bed contact time (EBCT) is between 1 and 6 minutes.

2. The apparatus according to claim 1, wherein the bed has a bed volume capacity of at least 10,000 bed volumes of water to be treated during normal operations.

3. The apparatus according to claim 1, wherein the bed has a bed volume capacity of at least 60,000 bed volume of water to be treated during normal operations.

4. The apparatus according to claim 1, wherein the bed has a bed volume capacity of at least 30,000 bed volume of water to be treated during normal operations between backwash operations.

5. The apparatus according to claim 1, wherein the bed has a bed volume capacity ranging from about 5 bed volumes of water to about 10 bed volumes of water during backwash operations.

6. The apparatus according to claim 1 wherein the apparatus is arranged for backwash operation having a flow rate of less than 50 m/h.

7. The apparatus according to claim 1 wherein the bed is arranged for backwash operation having a flow rate of less than 30 m/h.

8. The apparatus according to claim 1 wherein the apparatus is structured such that a forward flush immediately precedes a backwash operation.

9. The apparatus according to claim 8, wherein the apparatus is structured such that the forward flush comprises less then about 10 bed volumes of water.

10. The apparatus according to claim 8 wherein the apparatus is structured such that the forward flush comprises flushing water from the second supply from the said one side of the bed to the said other side of the bed.

11. The apparatus according to claim 8, wherein the apparatus is structured such that the forward flush has a flow rate of less than 30 m/h.

12. The apparatus according to claim 8, wherein the apparatus is structured such that the forward flush has a flow rate of less than 25 m/h.

13. The apparatus according to claim 1 wherein the adsorption chamber further comprises a base arranged to support the bed.

14. The apparatus according to claim 13, wherein the base includes one or more openings.

15. The apparatus according to claim 9 wherein the base comprises a wedgewire material.

16. The apparatus according to claim 1 wherein the granular ferric material has an average diameter of less than 2 mm and more than 0.25 mm, 10% or less of the granules have a diameter greater than 2 mm and 5% or less of the granules have a diameter less than 0.25 mm.

17. The apparatus according to claim 1, wherein the granular ferric material has an average diameter of about 0.8 mm.

18. The apparatus according to claim 1 wherein the granular ferric material is a granulated natural material.

19. The apparatus according to claim 1 wherein the granular ferric material comprises ferric hydroxide.

20. The apparatus according to claim 1 wherein the grain density ranges from about 1.5 kg/dm³ to about 1.7 kg/dm³.

21. The apparatus according to claim 1 wherein the grain density is about 1.58 kg/dm³.

22. The apparatus according to claim 21 wherein the average bulk density at 45% water content is at least 1.1 g/cm³ and no more than 1.4 g/cm³.

23. The apparatus according to claim 21 wherein the average bulk density at 45% water content is within a range of about 1.2 g/cm³ to 1.3 g/cm³.

24. The apparatus according to claim 21 wherein the average bulk density at 45% water content is approximately 1.25 g/cm³.

25. The apparatus according to claim 1 wherein the material has a specific surface of about 1.6×10⁵ m²/dm³.

26. The apparatus according to claim 1 wherein the material comprises at least 50% by weight iron.

27. The apparatus according to claim 1 wherein the bed includes a layer of gravel of greater average diameter than the ferric material.

28. The apparatus according to claim 1 where the metal is selected from the group consisting of arsenic; copper; cadmium, nickel; chromium; silver; lead; molybdenum; manganese; and mixtures thereof.

29. The apparatus according to claim 1 wherein the bed has a bed volume and the bed is structured such that the ferric material is replaced after at least 100,000 bed volumes of water have been treated in normal operation.

30. The apparatus according to claim 1 wherein the bed has a bed volume and the bed is structured such that the ferric material is replaced after at least 120,000 bed volumes of water have been treated in normal operation.

31. The apparatus according to claim 1 wherein the bed has a bed volume and the bed is structured such that the ferric material is replaced after at least 150,000 bed volumes of water have been treated in normal operation.

32. The apparatus according to claim 1 wherein the pH in the bed of the adsorption chamber is within the range of 7.0 and 8.5 during normal operation.

33. The apparatus according to claim 1 wherein the pH in the bed of the adsorption chamber is within the range of 7.5 and 8.0 during normal operation.

34. The apparatus according to claim 1 wherein the pH in the bed of the adsorption chamber is within the range of 7.8 during normal operation.

35. The apparatus according to claim 1 wherein the bed is at least 1 m in height and the bed has a volume of about 10 m³.

36. The apparatus according to claim 1 wherein the apparatus is arranged to provide a conditioning cycle when new bed material is added to the adsorption chamber, wherein the conditioning cycle comprises an initial bed stratification backwash, a conditioning backwash and a final conditioning forward flush.

37. The apparatus according to claim 36 wherein the initial bed stratification backwash comprises about 4 bed volumes of water at about 30 m/h.

38. The apparatus according to claim 36 wherein the final conditioning backwash comprises a backwash cycle as defined in the preceding claims.

39. The apparatus according to claim 36 wherein the conditioning forward flush comprises a forward flush as defined in the preceding claims.

40. The apparatus according to claim 1 wherein the apparatus is arranged to provide a loading backwash of about 10 bed volumes of water at less than 10 m/h e.g. about 5 m/h, when loading the bed material into the adsorption chamber.

41. The apparatus according to claim 1 wherein the apparatus includes a plurality of similar adsorption chambers having shared first water supplies and second water supplies.

42. The apparatus of claim 41 wherein one of the adsorption chambers is undergoing any backwash cycle or forward flush at any one time.

43. The apparatus according to claim 41 wherein the adsorption chambers comprise a first group and a second group and the first water supply is arranged to supply water at different rates to the first and second groups.

44. The apparatus according to claim 1 wherein the bed is structured such that the rate of water through the bed in normal operation is less than 50 m/h.

45. The apparatus according to claim 1 wherein the bed is structured such that the rate of water through the bed in normal operation is about 25 m/h.

46. The apparatus according to claim 1 wherein the EBCT in normal operation is about 3 minutes.

47. An apparatus for removing metals from water comprising:
an adsorption chamber including a bed adapted to absorb arsenic, the bed having a bed height ranging from about 0.5 m to about 2.0 m, the bed comprising a ferric material, the ferric material comprising a granular ferric material having a grain density ranging from about 1 kg/dm³ to about 2 kg/dm³, the bed comprising a bed volume capacity of at least 60,000 bed volumes of water to be treated during normal operations between backwash operations;
a water inlet connectable to a first water supply on one side of the bed;
a water outlet on the other side of the bed;
a backwash inlet connectable to a second water supply on the said other side of the bed;
wherein the apparatus is structured for normal operations and backwash operations, during normal operations, the apparatus is adapted for absorption of metals onto the bed as water flows from said one side to said other side, and the apparatus is structured for backwash operations as water flows from the backwash inlet to said one side of the bed and the empty bed contact time (EBCT) is between 1 and 6 minutes.wherein the.

48. A process for removing metal from water comprising:
a) providing a bed of ferric material having a bed height of between 0.5 and 2.0 m wherein the ferric material comprises a granular ferric material having a grain density between 1 to 2 kg/dm³;
b) in normal operation, supplying water from a first water supply from one side of the bed to the other side of the bed such that metal is adsorbed from the water onto the bed;
c) in backwash operation supplying water from a second water supply from said other side of the bed to said one side of the bed so as to remove contaminating material from the bed without substantially disrupting the media; wherein in normal operation, the empty bed contact time for said water is between 1 and 6 minutes.

49. The process according to claim 48 wherein at least 10,000 bed volumes of water are treated in normal operation between backwash operations.

50. The process according to claim 48 wherein at least 30,000 bed volumes of water are treated in normal operation between backwash operations.

51. The process according to claim 48 wherein 60,000 bed volumes of water are treated in normal operation between backwash operations.

52. The process according to claim 48 wherein the backwash operation comprises about 10 bed volumes of water.

53. The process according to claim 48 wherein the backwash operation comprises about 5 bed volumes of water.

54. The process according to claim 48 wherein the backwash operation has a flow rate of less than 50 m/h.

55. The process according to claim 48 wherein the backwash operation has a flow rate of less than 30 m/h.

56. The process according to claim 48 wherein a forward flush immediately precedes a backwash operation.

57. The process according to claim 56 wherein the forward flush comprises about 10 bed volumes of water.

58. The process according to claim 56 wherein the forward flush comprises about 5 bed volumes of water.

59. The process according to claim 56 wherein the forward flush comprises flushing water from the second supply from the said one side of the bed to the said other side of the bed.

60. The process according to claim 56 wherein the forward flush has a flow rate of less than 30 m/h.

61. The process according to claim 56 wherein the forward flush has a flow rate of less than 25 m/h.

62. The process according to claim 48, wherein the bed is supported on a base.

63. The process according to claim 62 wherein the base includes openings.

64. The process according to claim 62, wherein the base comprises a wedgewire material.

65. The process according to claim 48, wherein the granular ferric material has an average diameter of less than 2 mm and more than 0.25 mm, less than 10% of the granules have a diameter greater than 2 mm and less than 5% of the granules have a diameter less than 0.25 mm.

66. The process according to claim 48 wherein the granular ferric material has an average diameter of about 0.8 mm.

67. The process according to claim 48 wherein the granular ferric material is a granulated natural material.

68. The process according to claim 48 wherein the material comprises ferric hydroxide.

69. The process according to claim 48 wherein the grain density is between 1.5 to 1.7 kg/dm³.

70. The process according to claim 69 wherein the grain density is about 1.58 kg/dm³.

71. The process according to claim 69 wherein the average bulk density at 45% water content is at least 1.1 g/cm³ and/or no more than 1.4 g/cm³.

72. The process according to claim 69 wherein the average bulk density at 45% water content is within a range of from about 1.2 to about 1.3 g/cm³.

73. The process according to claim 69 wherein the average bulk density at 45% water content is about 1.25 g/cm³.

74. The process according to claim 48 wherein the granular ferric material has a specific surface of about 1.6×10⁵ m²/dm³.

75. The process according to 48, wherein the granular ferric material comprises at least 50% by weight iron.

76. The process according to claim 48, wherein the bed includes a layer of gravel of greater average diameter than the ferric material.

77. The process according to claim 48 wherein the metal removed from the water is selected from the group consisting of: arsenic; copper; cadmium; nickel; chromium; silver; lead molybdenum and mercury.

78. The process according to claim 48 wherein the ferric material is replaced after at least 100,000 bed volumes of water have been treated in normal operation.

79. The process according to claim 48 wherein the ferric material is replaced after at least 120,000 bed volumes of water have been treated in normal operation.

80. The process according to claim 48 wherein the ferric material is replaced after at least 150,000 bed volumes of water have been treated in normal operation.

81. The process according to claim 48 wherein the pH in the bed of the adsorption chamber is normal operation is within a range of about 7.0 to about 8.5.

82. The process according to claim 48 wherein the pH in the bed of the adsorption chamber is normal operation is within a range of about 7.5 to 8.0.

83. The process according to claim 48 wherein the pH in the bed of the adsorption chamber is normal operation is about 7.8.

84. The process according to claim 48, wherein the bed height is at least 1 m.

85. The process according to claim 48 wherein the process further comprises a conditioning cycle when new bed material is added to process, wherein the conditioning cycle comprises an initial bed stratification backwash, a final conditioning backwash and a final conditioning forward flush.

86. The process according to claim 85 wherein the initial bed stratification backwash comprises about four bed volumes of water at about 30 m/h.

87. The process according to claim 85 wherein the final conditioning backwash comprises a backwash cycle as defined in any of the preceding claims.

88. The process according to claim 85 wherein the conditioning forward flush comprises a forward flush as herein before defined in any of the preceding claims.

89. A process for removing arsenic from water comprising:
a) providing a bed of ferric material having a bed height of between 0.5 and 2.0 m wherein the ferric material comprises a granular ferric material having a grain density between 1 to 2 kg/dm³;
b) in normal operation, supplying water from a first water supply from one side of the bed to the other side of the bed such that metal is adsorbed from the water onto the bed wherein 60,000 bed volumes of water are treated in normal operation between backwash operations;
c) in backwash operation supplying water from a second water supply from said other side of the bed to said one side of the bed so as to remove contaminating material from the bed without substantially disrupting the media; wherein in normal operation, the empty bed contact time for said water is between 1 and 6 minutes;
(d) replacing the ferric material after at least 120,000 bed volumes of water have been treated in normal operation.

90. A process for removing metal from water comprising:
a) providing a bed of ferric material having a bed height of between 0.5 and 2.0 m wherein the ferric material comprises a granular ferric material having a grain density between 1 to 2 kg/dm³;
b) in normal operation, supplying water from a first water supply from one side of the bed to the other side of the bed such that metal is adsorbed from the water onto the bed wherein 60,000 bed volumes of water are treated in normal operation between backwash operations;
c) in backwash operation supplying water from a second water supply from said other side of the bed to said one side of the bed so as to remove contaminating material from the bed without substantially disrupting the media; wherein in normal operation, the empty bed contact time for said water is between 1 and 6 minutes;
(d) replacing the ferric material after at least 120,000 bed volumes of water have been treated in normal operation;
(e) performing a conditioning cycle when new bed material is added to process, wherein the conditioning cycle comprises an initial bed stratification backwash, a final conditioning backwash and a final conditioning forward flush.
